(19) United States
(12) Patent Application Publication
(10) Pub. No.: US 2010/0009216 A1
(43) Pub. Date: Jan. 14, 2010

(54) PERFLUOROPOLYETHER LUBRICANT THIN FILM FOR THIN FILM STORAGE MEDIUM

(75) Inventors: Jianwei Liu, Fremont, CA (US); Michael Joseph Stirniman, Fremont, CA (US); Jing Gui, Fremont, CA (US)

Correspondence Address: Shumaker & Sieffert, P.A., 1625 Radio Drive, Suite 300, Woodbury, MN, 55125, US

(73) Assignee: SEAGATE TECHNOLOGY LLC, Scotts Valley, CA (US)

(21) Appl. No.: 12/169,550

(22) Filed: Jul. 8, 2008

(51) Int. Cl. G11B 5/733; C08G 73/24; B05D 5/12

(52) U.S. Cl. 428/800; 528/401; 427/131

(57) ABSTRACT

The invention relates to a magnetic recording medium having a solid lubricant film layer which is deposited by plasma-enhanced chemical vapor deposition. The solid lubricant film comprises a perfluoropolyether, which is formed by the polymerization of a perfluorocycloalkane.

### BACKGROUND

Magnetic discs with magnetizable media are used for data storage in most all computer systems. Current magnetic hard disc drives operate with the read-write heads only a few nanometers above the disc surface and at rather high speeds, typically a few meters per second. Because the read-write heads can contact the disc surface during operation, a layer of lubricant is coated on the disc surface to reduce wear and friction.

FIG. 1(a) shows a disk recording medium and a cross section of a disc showing the difference between longitudinal and perpendicular recording. Although FIG. 1 shows one side of the non-magnetic disk, magnetic recording layers are sputter deposited on both sides of the non-magnetic aluminum substrate of FIG. 1(a). Also, although FIG. 1(a) shows an aluminum substrate, other embodiments include a substrate made of glass, glass-ceramic, NiP/aluminum, metal alloys, plastic/polymer material, ceramic, glass-polymer, composite materials or other non-magnetic materials.

A longitudinal recording disk medium is depicted in FIG. 1(b) and typically comprises a non-magnetic substrate 10 having sequentially deposited on each side thereof an underlayer 11,11′, such as chromium (Cr) or Cr-alloy, a magnetic layer 12,12′, typically comprising a cobalt (Co)-base alloy, and a protective overcoat 13,13′, typically containing carbon. Typical practices also include bonding a lubricant topcoat 14,14′ to the protective overcoat. Underlayer 11,11′, magnetic layer 12,12′, and protective overcoat 13,13′, are typically deposited by sputtering techniques. The Co-base alloy magnetic layer normally comprises polycrystallites epitaxially grown on the polycrystal Cr or Cr-alloy underlayer.

A perpendicular recording disk medium is similar to the longitudinal recording medium depicted in FIG. 1(b), but does not comprise Cr-containing underlayers.

Generally, the lubricant is applied to the disc surface by dipping the disc in a bath containing the lubricant. The bath typically contains the lubricant and a coating solvent to improve the coating characteristics of the lubricant, which is usually viscous oil. The discs are removed from the bath, and the solvent is allowed to evaporate, leaving a layer of lubricant on the disc surface.

The lubricant film on hard discs provides protection to the underlying magnetic alloy by preventing wear of the carbon overcoat. In addition, it works in combination with the overcoat to provide protection against corrosion of the underlying magnetic alloy.

The mechanical reliability of hard disks is dependent on the durability of the thin film storage media. As the spacing between the read-write head and the rotating disc is aggressively reduced to improve areal storage density, the media suffer technical difficulties, such as weak durability, heavy lubricant pickup, and unmanageable stiction/friction. Lubrication plays an important role in overcoming these difficulties. Solid lubricant films have been used to prevent lubricant pickup and for the reduction of stiction. Moreover, the low volatility of solid lubricants makes them attractive for heat-assisted magnetic recording (HAMR). However, a major technical problem associated with solid lubricants is the weak durability and bonding of the lubricant to the underlying layers. Previously known solid lubricants, including sputtered Teflon and dip-lubed solid lubricants, have failed during industrial standard post-lubing processes, such as buffing, wiping and banishing.

One method of preparing a solid thin lubricant film on the disc surface uses plasma-enhanced chemical vapor deposition (PECVD). PECVD of a fluorocarbon thin film usually produces highly cross-linked polymers. For example, FIG. 2 shows a schematic PECVD polymerization of trifluroromethane.

However, highly cross-linked perflurorocarbon polymers have weak wear resistance due to their rigid chemical structure, which has little molecular mobility to relax external shear stress. Scratches and wear on media after post-lubrication processes and after contact start-stop (CSS) testing are generally observed.

### SUMMARY

The invention relates to magnetic recording media having a solid lubricant film comprising a plasma-enhanced chemical vapor deposited perfluoropolyether, where the perfluoropolyether is a polymerized perfluorocycloalkane.

According to one embodiment, the plasma-enhanced chemical vapor deposited perfluoropolyether comprises

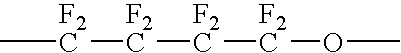

In another embodiment, the perfluorocycloalkane comprises 3 to 10 carbon atoms. In yet another embodiment, the perfluorocycloalkane is octafluorocyclobutane.

The magnetic recording medium may also include a magnetic recording layer and a protective overcoat layer on the magnetic layer, where the solid lubricant film is located on the protective overcoat layer.

The invention also relates to magnetic recording media having a solid lubricant film comprising a polymer comprising C, F and O, where the polymer is a polymerized perfluorocycloalkane.

The invention also provides a method of manufacturing a magnetic recording medium comprising forming a magnetic recording layer on a substrate, forming a protective overcoat layer on the magnetic recording layer, exposing a surface of the protective overcoat layer to an atmosphere comprising a perfluorocycloalkane and oxygen, and depositing a perfluoropolyether-containing layer on the protective overcoat layer. The atmosphere may further comprise a hydrocarbon.

According to one embodiment, the oxygen is present in the atmosphere in an amount of about 1% to about 30%. According to another embodiment, the oxygen and hydrocarbon are present in the atmosphere in a combined amount of about 1% to about 30%. In another embodiment, the atmosphere is maintained at a temperature of about 20° C. to about 150° C. In yet another embodiment, the atmosphere is maintained at a pressure of about 0.1 to about 10 Torr.

Additional advantages of this invention will become readily apparent to those skilled in this art from the following detailed description, wherein only the preferred embodiments of the invention are shown and described, by way of illustration of the best mode contemplated for carrying out the invention. As will be realized, this invention is capable of other and different embodiments, and its details are capable of modifications in various obvious respects, all without departing from the invention. Accordingly, the drawings and description are to be regarded as illustrative in nature and not as restrictive.

### BRIEF DESCRIPTION OF THE DRAWINGS

The present invention will be better understood by reference to the Detailed Description when taken together with the attached drawings, wherein:

FIG. 1(a) shows a magnetic recording medium and a cross section of a disc depicting longitudinal and perpendicular recording.

FIG. 1(b) schematically shows a conventional longitudinal recording disk medium.

FIG. 2 shows a schematic PECVD polymerization of trifluoromethane to a cross-linked fluoropolymer.

FIG. 3 shown an inline process for manufacturing magnetic recording media.

FIG. 4 shows a schematic PECVD polymerization of octafluorocyclobutane to a minimally cross-linked perfluoropolyether in the presence of oxygen.

FIG. 5 shows the particle counts on a disc surface after post-lubrication processes.

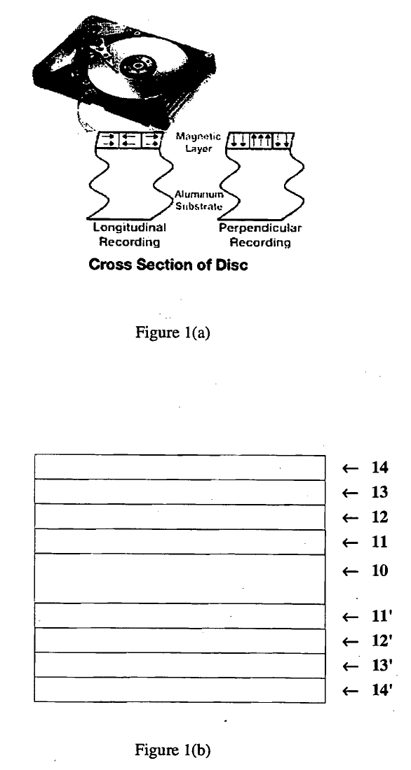

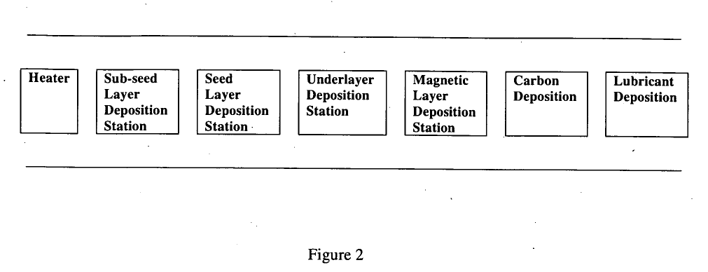

### DETAILED DESCRIPTION

The invention is directed to a method of coating a substrate, particularly recording media (recording discs), with a solid lubricant, which is also referred in the specification to as a “lube.” Lubricants typically are liquid and contain molecular weight components that range from several hundred Daltons to several thousand Daltons.

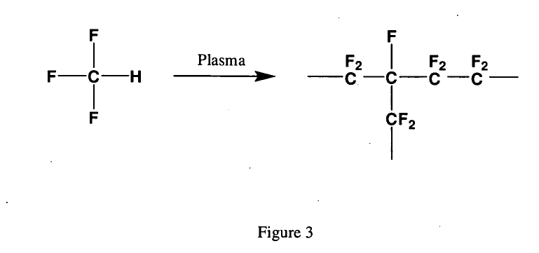

An inline process for manufacturing magnetic recording media is schematically illustrated in FIG. 3. The disc substrates travel sequentially from the heater to a sub-seed layer deposition station and a sub-seed layer is formed on the disc substrates. Then, the disc substrates travel to a seed layer station for deposition of the seed layer, typically NiAl. Subsequent to the deposition of the sub-seed layer and the seed layer, the disc substrates are passed through the underlayer deposition station wherein the underlayer is deposited. The discs are then passed to the magnetic layer deposition station and then to the protective carbon overcoat deposition station. Finally, the discs are passed through a lubricant film deposition station.

Almost all the manufacturing of the disks takes place in clean rooms, where the amount of dust in the atmosphere is kept very low, and is strictly controlled and monitored. The disk substrates come to the disk fabrication site packed in shipping cassettes. For certain types of media, the disk substrate has a polished nickel-coated surface. The substrates are preferably transferred to process cassettes to be moved from one process to another. Preferably, the cassettes are moved from one room to another on automatic guided vehicles to prevent contamination due to human contact.

The first step in preparing a disk for recording data is mechanical texturing by applying hard particle slurry to the polished surface of the substrate and to utilize proper tape materials on circumferential motion disk to create circumferentially texture grooves. This substrate treatment helps in depositing of a preferred underlayer crystallographic orientation and subsequently helps preferentially growth of magnetic recording material on the substrate. During the texturing process, small amounts of substrate materials get removed from surface of the disk and remain there. To remove this, the substrate is usually washed. Also, techniques for polishing the surface of the non-magnetic substrate of a recording medium use slurry polishing, which requires wash treatment. Thus, disk substrates are washed after texturing and polishing. However, wash defects could be one of the top yield detractors.

A final cleaning of the substrate is then done using a series of ultrasonic, megasonic and quick dump rinse (QDR) steps. At the end of the final clean, the substrate has an ultra-clean surface and is ready for the deposition of layers of magnetic media on the substrate. Preferably, the deposition is done by sputtering.

Sputtering is perhaps the most important step in the whole process of creating recording media. There are two types of sputtering: pass-by sputtering and static sputtering. In pass-by sputtering, disks are passed inside a vacuum chamber, where they are bombarded with the magnetic and non-magnetic materials that are deposited as one or more layers on the substrate. Static sputtering uses smaller machines, and each disk is picked up and sputtered individually.

The sputtering layers are deposited in what are called bombs, which are loaded into the sputtering machine. The bombs are vacuum chambers with targets on either side. The substrate is lifted into the bomb and is bombarded with the sputtered material.

Sputtering leads to some particulate formation on the post sputter disks. These particulates need to be removed to ensure that they do not lead to the scratching between the head and substrate. Thus, a lube is preferably applied to the substrate surface as one of the top layers on the substrate.

Once a lube is applied, the substrates move to the buffing/burnishing stage, where the substrate is polished while it preferentially spins around a spindle. After buffing/burnishing, the substrate is wiped and a clean lube is evenly applied on the surface.

Subsequently, the disk is prepared and tested for quality thorough a three-stage process. First, a burnishing head passes over the surface, removing any bumps (asperities as the technical term goes). The glide head then goes over the disk, checking for remaining bumps, if any. Finally the certifying head checks the surface for manufacturing defects and also measures the magnetic recording ability of the substrate.

The invention involves a method of preparing a thin lubricant film using plasma-enhanced chemical vapor deposition (PECVD) on the top of carbon overcoat of magnetic storage media. Just as solids, liquids and gases are states of matter, plasma is a state of matter, specifically an ionized gas. That is, gas that has been given an electrical charge by being stripped of electrons.

The inventors recognized that conventional fluorocarbon precursors, such as trifluoromethane, can be randomly cross-linked in the PECVD process. To minimize such random reactions, the present invention involves using perfluorocycloalkane precursors, which contain specific chemical bonds that can be broken preferentially under plasma conditions. The cycloalkane C—C bond is more susceptible to cleavage than the C—F bond. When the power of the plasma is carefully controlled, it is possible to keep most of the C—F bonds intact during the deposition process.

The plasma polymerization process uses a perfluorocycloalkane precursor, such as octafluorocyclobutane, and a small amount of oxygen. The resulting film has very low surface energy, good scratch resistance for post-lubrication processes, and good flyability and CSS durability.

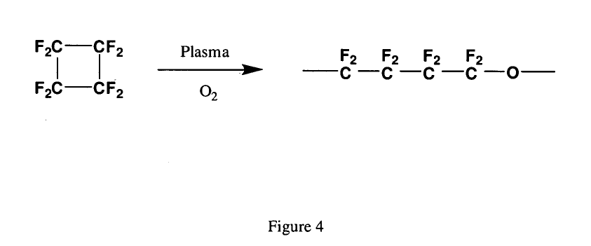

FIG. 4 shows the plasma polymerization of octafluorocyclobutane in the presence of oxygen to form a solid lubricant film of this invention. The resulting polymer is only minimally cross-linked.

The presence of oxygen during the plasma reaction shown in FIG. 4 generates highly active oxygen radicals and ions, which can etch the surface film. To reduce the reactivity of oxygen plasma, a hydrocarbon gas, such as methane, ethane, propane, butane, pentane, and hexane, may be added to the plasma system as a stabilizer. By controlling the amount of the hydrocarbon stabilizer, etching can be entirely inhibited.

The process flow rates of the perfluorocycloalkane, oxygen and the optional hydrocarbon depend upon the plasma system. The combined oxygen and optional hydrocarbon stabilizer in the plasma process chamber are controlled in the range of about 1% to about 30%. The process temperature ranges from about 20° C. to about 150 C, and the pressure ranges from about 0.1 to about 10 Torr.

When the temperature of the plasma system is greater than about 150° C., the perfluoropolyether lubricant film tends to degrade. A rapid surface energy increase of the deposited film is observed as the process temperature exceeds about 150 C.

The degree of cross-linking can be further reduced by selecting perfluorocycloalkane precursors having a larger cycloalkane ring. For example, plasma polymerization of octafluorocyclobutane generally produces less cross-linking than hexafluorocyclopropane. The preferred number of carbons in the perfluorocycloalkane precursor is 3 to 10.

Solid lubricant films prepared according to the present invention have very low surface energy. For example, the water contact angle (WCA) of the deposited film can be as high as 110°, compared to the 80-90° of a conventionally applied lubricant film.

The solid lubricant film of this invention also has the following desirable properties. The film contains no solvent or liquid that could evaporate or spin-off the disc under fast rotation. Also, while a liquid lubricant could be picked-up by the read-write head of the disc drive, the use of a solid lubricant prevents this problem. Finally, under high speed rotation of the disc, the solid lubricant will not form ripples as is possible with a liquid lubricant.

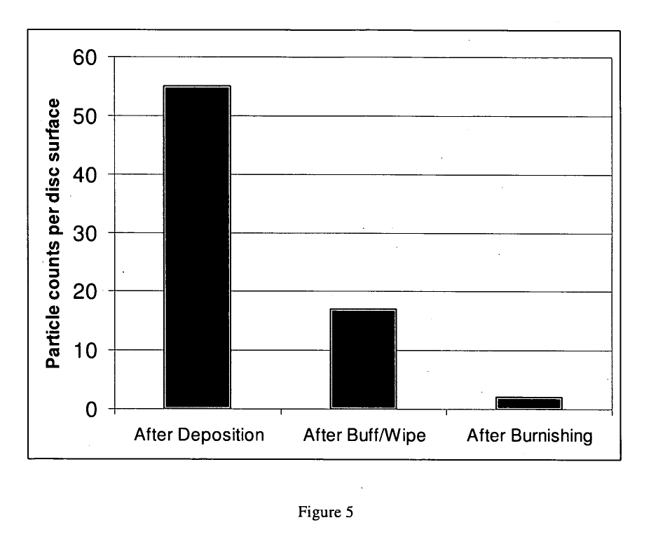

Recording media subjected to these post-lubrication processes exhibit lower particulate counts. FIG. 5 compares the amount of particulates on a disc surface after deposition, after buff/wipe, and after burnishing.

The PECVD film prepared according to this invention demonstrates excellent flyability and CSS durability. The interfaces survived a four-day flyability test that included sweeping the read-write head from the inside diameter to the outside diameter and also survived 20,000 CSS cycles.

In this application, the word “containing” means that a material includes the elements or compounds following the word “containing,” but the material could still include other elements and compounds. This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

What is claimed is:

1. A magnetic recording medium comprising a solid lubricant film comprising a plasma-enhanced chemical vapor deposited perfluoropolyether, wherein the perfluoropolyether is a polymerized perfluorocycloalkane.

2. The magnetic recording medium of claim 1, wherein the plasma-enhanced chemical vapor deposited perfluoropolyether comprises

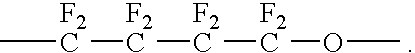

3. The magnetic recording medium of claim 1, wherein the perfluorocycloalkane comprises 3 to 10 carbon atoms.

4. The magnetic recording medium of claim 1, wherein the perfluorocycloalkane is octafluorocyclobutane.

5. The magnetic recording medium of claim 1, further comprising a magnetic recording layer and a protective overcoat layer on the magnetic layer, wherein the solid lubricant film is located on the protective overcoat layer.

6. A magnetic recording medium comprising a solid lubricant film comprising a polymer comprising C, F and O, wherein the polymer is a polymerized perfluorocycloalkane.

7. The magnetic recording medium of claim 6, wherein the polymer comprises

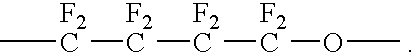

8. The magnetic recording medium of claim 6, wherein the polymer comprises one oxygen per 3 to 10 carbon atoms.

9. The magnetic recording medium of claim 6, wherein the perfluorocycloalkane is octafluorocyclobutane.

10. The magnetic recording medium of claim 6, further comprising a magnetic recording layer and a protective overcoat layer on the magnetic layer, wherein the solid lubricant film is located on the protective overcoat layer.

11. A method of manufacturing a magnetic recording medium comprising forming a magnetic recording layer on a substrate, forming a protective overcoat layer on the magnetic recording layer, exposing a surface of the protective overcoat layer to an atmosphere comprising a perfluorocycloalkane and oxygen, and depositing a perfluoropolyether-containing layer on the protective overcoat layer.

12. The method of claim 11, wherein the perfluorocycloalkane comprises 3 to 10 carbon atoms.

13. The method of claim 11, wherein the perfluorocycloalkane is octafluorocyclobutane.

14. The method of claim 11, wherein the perfluoropolyether-containing layer comprises a polymer comprising

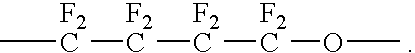

15. The method of claim 11, wherein the perfluoropolyether-containing layer comprises one oxygen per 3 to 10 carbon atoms.

16. The method of claim 11, wherein the oxygen is present in the atmosphere in an amount of about 1% to about 30%.

17. The method of claim 11, wherein the atmosphere further comprises a hydrocarbon.

18. The method of claim 17, wherein the oxygen and hydrocarbon are present in the atmosphere in a combined amount of about 1% to about 30%.

19. The method of claim 11, wherein the atmosphere is maintained at a temperature of about 20° C. to about 150° C.

20. The method of claim 11, wherein the atmosphere is maintained at a pressure of about 0.1 to about 10 Torr.
